(19) United States
(12) Patent Application Publication
(10) Pub. No.: US 2015/0362198 A1
(43) Pub. Date: Dec. 17, 2015

(54) DEHUMIDIFICATION APPARATUS AND DEHUMIDIFICATION METHOD

(71) Applicant: Unimicron Technology Corp., Taoyuan (TW)

(72) Inventors: Been-Wei Liaw, Taichung City (TW); Hau-Chieh Lin, Kaohsiung City (TW)

(21) Appl. No.: 14/304,977

(22) Filed: Jun. 15, 2014

(51) Int. Cl. F24F 3/14; B01D 53/26; B01D 53/24

(52) U.S. Cl. CPC F24F 3/14; B01D 53/24; B01D 53/26; F24F 2003/144

(57) ABSTRACT

A dehumidification apparatus suitable for collecting gas of an exterior and excluding moisture from the gas is provided. The dehumidification apparatus includes an intake tube, a throat tube, an exhaust tube, and a communication device. The intake tube has a first end portion and a second end portion opposite to each other, wherein the cross-section of the intake tube is convergent from the first end portion to the second end portion. The throat tube is connected to the second end portion. The exhaust tube is connected to the throat tube, wherein the throat tube is located between the second end portion and the exhaust tube, and the cross-section of the throat tube is less than the cross-section of the exhaust tube. The communication device is connected between the intake tube and the exhaust tube. A dehumidification method is also provided.

### BACKGROUND OF THE INVENTION

1. Field of the Invention

The invention is related to a dehumidification apparatus and a dehumidification method, and more particularly, to a dehumidification apparatus using a supersonic nozzle and a dehumidification method.

2. Description of Related Art

For the current air conditioning dehumidification system, designs of, for instance, a frozen dehumidification method, a desiccant wheel dehumidification method, a chemical dehumidification method, and a membrane dehumidification method are common. The defects of these designs are described herein. The frozen dehumidification method uses a refrigerant as a medium and performs moisture absorption and cooling using compression and cooling principles. However, the power consumption of the frozen dehumidification method is relatively significant. The desiccant wheel dehumidification method achieves the effect of dehumidification through a rotating wheel, wherein the rotating wheel can substantially be divided into an adsorption side and a regeneration side opposite to each other. In general, the adsorption side is filled with a resin to absorb moisture from the air, and the regeneration side performs heating regeneration to remove the moisture. However, the amount of gas that can be treated by the rotating wheel is less, and therefore the rotating wheel is not suitable for large air conditioners. Moreover, the power consumed during the heating regeneration is also relatively significant.

In the chemical dehumidification method, a chemical solution and external air are thoroughly mixed through principles of scrubber, wherein the vapor pressure of the chemical solution is lower than the vapor pressure of the moisture in the external air, and the difference in vapor pressure between the two can be used as a mass transfer driving force for dehumidification. However, when excessive amount of moisture absorbed by the chemical solution causes a significant decrease in the concentration thereof, a heating regeneration method is needed to restore the initial concentration of the chemical solution such that the chemical solution can be recycled. However, the power consumed during the heating regeneration is relatively significant. In the membrane dehumidification method, moisture in external air is adsorbed with a macromolecular dialysis membrane to achieve the effect of dehumidification. However, the amount of gas that can be treated by the macromolecular dialysis membrane is too low, and therefore the macromolecular dialysis membrane is not suitable for large air conditioners. Moreover, the material cost of the macromolecular dialysis membrane is high.

### SUMMARY OF THE INVENTION

The invention provides a dehumidification apparatus and a dehumidification method capable of making a gas reach supersonic speed for dehumidification and lowering power consumption and operating costs.

The dehumidification apparatus of the invention is suitable for collecting the gas of an exterior and excluding moisture from the gas. The dehumidification apparatus includes an intake tube, a throat tube, an exhaust tube, and a communication device. The intake tube has a first end portion and a second end portion opposite to each other, wherein the cross-section of the intake tube is convergent from the first end portion to the second end portion. The throat tube is connected to the second end portion. The exhaust tube is connected to the throat tube, wherein the throat tube is located between the second end portion and the exhaust tube, and the cross-section of the throat tube is less than the cross-section of the exhaust tube. The communication device is connected between the intake tube and the exhaust tube.

In an embodiment of the invention, the ratio between the cross-section of the throat tube and the cross-section of the exhaust tube is 1:1.2.

In an embodiment of the invention, the communication device includes a first communication tube, a control valve, and a pump. The first communication tube is connected between the intake tube and the exhaust tube. The control valve is connected to the first communication tube. The pump is connected to the first communication tube and located between the exhaust tube and the control valve.

In an embodiment of the invention, the dehumidification apparatus further includes an airflow guiding device. The airflow guiding device is connected to the intake tube, and the intake tube is located between the throat tube and the airflow guiding device.

In an embodiment of the invention, the dehumidification apparatus further includes two pitot tubes. The two pitot tubes are respectively disposed inside the airflow guiding device and the exhaust tube.

In an embodiment of the invention, the airflow guiding device includes a cover body, a plurality of guide vanes, and a second communication tube. The guide vanes are pivoted inside the cover body and radially arranged about the central axis of the cover body. The second communication tube is connected between the cover body and the first end portion, and the cross-section of the second communication tube is convergent from the cover body to the first end portion.

The dehumidification method of the invention includes the following steps. First, a dehumidification apparatus is provided. The dehumidification apparatus includes an intake tube, a throat tube, an exhaust tube, and a communication device connected between the intake tube and the exhaust tube, wherein the intake tube has a first end portion and a second end portion opposite to each other, and the cross-section of the intake tube is convergent from the first end portion to the second end portion. The throat tube is connected between the second end portion and the exhaust tube, and the cross-section of the throat tube is less than the cross-section of the exhaust tube. Then, the gas of an exterior is introduced from the first end portion with the intake tube, and the gas is accelerated such that the gas enters the throat tube from the second end portion and reaches supersonic speed when passing through the throat tube. Next, the gas is continuously accelerated with the throat tube and the exhaust tube, and moisture is removed from the gas.

In an embodiment of the invention, the dehumidification method further includes the following steps. First, the gas inside the exhaust tube is extracted with the pump and transported to the control valve through the first communication tube. Then, the exterior and the first communication tube are communicated through the control valve to emit the gas inside the exhaust tube to the exterior, and the pump and the control valve are turned off after the atmospheric pressure inside the intake tube is relatively higher than the atmospheric pressure inside the exhaust tube. Next, the gas inside the intake tube is pushed to the throat tube and the exhaust tube with the pressure difference between the atmospheric pressure inside the intake tube and the atmospheric pressure inside the exhaust tube, and the gas is accelerated to supersonic speed.

In an embodiment of the invention, the following steps are further included before the gas is continuously accelerated with the throat tube and the exhaust tube and a normal shock is generated. First, the gas inside the exhaust tube is extracted with the pump and transported to the control valve through the first communication tube. Then, the intake tube and the first communication tube are communicated with the control valve to transport the gas inside the exhaust tube to the intake tube such that the gas is accelerated to supersonic speed when passing through the throat tube.

In an embodiment of the invention, the dehumidification method further includes the following steps. An airflow guiding device and the intake tube are connected, wherein the intake tube is located between the throat tube and the airflow guiding device, the gas of an exterior is collected and entered into the intake tube with the airflow guiding device, and the gas rotates about the central axis of the airflow guiding device.

In an embodiment of the invention, the dehumidification method further includes the following steps. Two pitot tubes are respectively disposed inside the airflow guiding device and the exhaust tube to detect the flow rate of the gas passing through the airflow guiding device and the flow rate of the gas passing through the exhaust tube.

Based on the above, since the intake tube, the throat tube, and the exhaust tube of the invention form a convergent-divergent nozzle, based on the principles of aerodynamics, the gas passing through the intake tube, the throat tube, and the exhaust tube can be accelerated to supersonic speed. As a result, moisture from the gas can be excluded, and power consumption and operating costs can be lowered.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a dehumidification apparatus according to an embodiment of the invention.

FIG. 2 is a front view of an airflow guiding device of FIG. 1.

### DESCRIPTION OF THE EMBODIMENTS

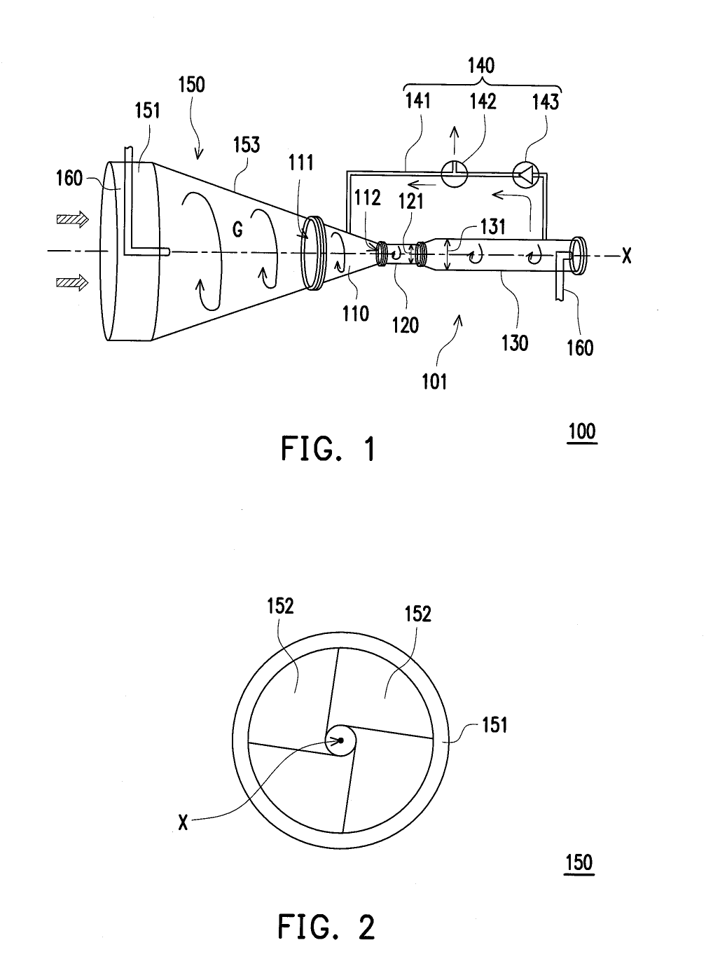

FIG. 1 is a schematic diagram of a dehumidification apparatus according to an embodiment of the invention, wherein a gas G is represented by an arrow. Referring to FIG. 1, in the present embodiment, a dehumidification apparatus 100 is suitable for collecting the gas G of an exterior and excluding moisture from the gas G. The dehumidification apparatus 100 includes an intake tube 110, a throat tube 120, an exhaust tube 130, and a communication device 140, wherein the intake tube 110, the throat tube 120, and the exhaust tube 130 connected in sequence are disposed on the same axis to form a nozzle 101.

The intake tube 110 has a first end portion 111 and a second end portion 112 opposite to each other, wherein the cross-section of the intake tube 110 perpendicular to an axis X is convergent from the first end portion 111 to the second end portion 112. That is, the intake tube 110 has a convergent form. The throat tube 120 is connected between the second end portion 112 and the exhaust tube 130, wherein a plurality of cross-sections 121 (only one cross-section 121 is shown in FIG. 1) of the throat tube 120 perpendicular to the axis X are equal to one another, and a plurality of cross-sections 131 (only one cross-section 131 is shown in FIG. 1) of the exhaust tube 130 perpendicular to the axis X are equal to one another. However, the cross-sections 121 are less than the cross-sections 131. In other words, the throat tube 120 and the exhaust tube 130 in communication with each other have a divergent form, and the ratio between the cross-sections 121 and the cross-sections 131 can be 1:1.2.

Since the cross-section of the intake tube 110 perpendicular to the axis X is convergent from the first end portion 111 to the second end portion 112, and the cross-sections 121 of the throat tube 120 are less than the cross-sections 131 of the exhaust tube 130, the intake tube 110, the throat tube 120, and the exhaust tube 130 of the present embodiment can form a convergent-divergent nozzle 101.

Specifically, the communication device 140 includes a first communication tube 141, a control valve 142, and a pump 143. The first communication tube 141 is connected between the intake tube 110 and the exhaust tube 130 and is capable of pulling out the gas G inside the exhaust tube 130 in a timely manner. The control valve 142 is, for instance, connected to the first communication tube 141 as a two-way valve, wherein based on operational needs, the first communication tube 141 can be communicated with the exterior or the first communication tube 141 can be communicated with the intake tube 110 through the control valve 142. Moreover, the pump 143 is connected to the first communication tube 140 and located between the exhaust tube 130 and the control valve 142. In other words, the communication device 140, for instance, pulls out the gas G inside the exhaust tube 130 through the on and off of the pump 143. Moreover, whether the gas G pulled out is emitted to the exterior or transported to the intake tube 110 can be decided by the control valve 142.

FIG. 2 is a front view of an airflow guiding device of FIG. 1. Referring to FIG. 1 and FIG. 2, in the present embodiment, the dehumidification apparatus 100 further includes an airflow guiding device 150. The airflow guiding device 150 is connected to the intake tube 110, and the intake tube 110 is located between the throat tube 120 and the airflow guiding device 150. Specifically, the airflow guiding device 150 can include a cover body 151, a plurality of guide vanes 152, and a second communication tube 153. The guide vanes 152 are pivoted inside the cover body 151 and radially arranged about the central axis of the cover body 151. Since the cover body 151 and the second communication tube 153 are, for instance, disposed on the same axis as the nozzle 101, the central axis of the cover body 151 is substantially the same as the axis X. In general, the guide vanes 152 rotating about the axis X can introduce the gas G of an exterior into the second communication tube 153 and generate centrifugal acceleration (such as 6×10⁵ G) to form one of the requirements of separating moisture from the gas G.

In other words, the gas G is, for instance, a vortex flow substantially rotating about the axis X. Therefore, during the rotation of the gas G, moisture in the gas G is separated therefrom due to the effect of centrifugal acceleration, wherein the moisture separated from the gas G can be condensed into droplets due to temperature drop and be pushed to the exhaust tube 130 for discharge. In general, the discharged droplets can be recycled with a collection tank (not shown) and are not scattered around. Moreover, the second communication tube 153 is connected between the cover body 151 and the first end portion 111, and the cross-section of the second communication tube 153 perpendicular to the axis X is convergent from the cover body 151 to the first end portion 111. In other words, the airflow guiding device 150 and the nozzle 101 connected to each other still have a convergent-divergent form.

In the following description, the dehumidification apparatus 100 accelerating the gas G to supersonic speed and the dehumidification method excluding moisture from the gas G are further described. In particular, the structural configuration of the dehumidification apparatus 100 is as described above and is not repeated herein. Referring to FIG. 1 and FIG. 2, first, the gas G of an exterior is introduced from the first end portion 111 with the intake tube 110, and the gas G is accelerated such that the gas G enters the throat tube 120 from the second end portion 112. Specifically, the gas G is, for instance, collected and entered into the intake tube 110 with the airflow guiding device 150. Moreover, in the case that the gas G is introduced into the second communication tube 153 by using the guide vanes 152 rotating about the axis X, the centrifugal acceleration (such as 6×10⁵ G)generated by the guide vanes 152 can first separate the moisture from the gas G. At this point, the gas G rotates about the central axis (i.e., the axis X) of the airflow guiding device 150.

Then, the gas G of an exterior (i.e., the gas collected by the airflow guiding device 150) is introduced from the first end portion 111 with the intake tube 110, and the gas G is accelerated such that the gas G enters the throat tube 120 from the second end portion 112. Since the cross-section of the intake tube 110 perpendicular to the axis X is convergent from the first end portion 111 to the second end portion 112, that is, the intake tube 110 has a convergent form, it can be known from the principles of aerodynamics and mass conservation that, the flow rate of the gas G passing through the second end portion 112 is greater than the flow rate of the gas G passing through the first end portion 111. The following is a mass conservation equation (1).

\dot{m}=ρVA=const (1)

In particular, \dot{m} is the mass flow rate of the gas G, ρ is the density of the gas G, and V is the flow rate of the gas G passing through a cross-section A. In other words, when the mass flow rate of the gas G is a constant value, and the cross-section of the intake tube 110 perpendicular to the axis X is convergent from the first end portion 111 to the second end portion 112, the flow rate of the gas G passing through the second end portion 112 is greater than the flow rate of the gas G passing through the first end portion 111, and the gas G is accelerated to supersonic speed when passing through the throat tube 120.

At this point, the gas G accelerated to supersonic speed no longer follows the principle of increasing flow rate with decreasing cross-section and decreasing flow rate with increasing cross-section. On the contrary, when the gas G accelerated to supersonic speed is pushed from a smaller cross-section to a larger cross-section, the flow rate thereof is continuously increased and the gas G is always maintained in a supersonic state. In other words, since the cross-sections 121 of the throat tube 120 are less than the cross-sections 131 of the exhaust tube 130, that is, the cross-sections of each of the throat tube 120 and the exhaust tube 130 are configured in a divergent form, the flow rate of the gas G accelerated to supersonic speed can be continuously increased.

Moreover, to ensure that the gas G can still be pushed to the throat tube 120 and reach a supersonic flow rate when the intake tube 110 is in a low pressure state, the gas G inside the exhaust tube 130 can first be extracted with the pump 143 and then be transported to the control valve 142 through the first communication tube 141. Then, the exterior and the first communication tube 141 are communicated with the control valve 142 to emit the gas G inside the exhaust tube 130 to the exterior, and the pump 143 and the control valve 142 are turned off after the atmospheric pressure inside the intake tube 110 is relatively higher than the atmospheric pressure inside the exhaust tube 130. Next, the gas G inside the intake tube 110 is readily pushed to the throat tube 120 and the exhaust tube 130 through the pressure difference between the atmospheric pressure inside the intake tube 110 and the atmospheric pressure inside the exhaust tube 130, and the gas G is accelerated to supersonic speed.

To prevent the generation of a normal shock when the gas G accelerated to supersonic speed passes through the throat tube 120 and the exhaust tube 130 and to prevent the normal shock from affecting the maintenance of the flow rate (supersonic speed) of the gas G, before the gas G is continuously accelerated by the throat tube 120 and the exhaust tube 130 and a normal shock is generated, the gas G inside the exhaust tube 130 can first be transported to the intake tube 110 by communicating the intake tube 110 and the first communication tube 141 with the control valve 142 such that the gas G can still be accelerated to supersonic speed when passing through the throat tube 120. In particular, the flow rate of the gas G passing through the airflow guiding device 150 and the flow rate of the gas G passing through the exhaust tube 130 can be detected by respectively disposing a corresponding pitot tube 160 inside the airflow guiding device 150 and the exhaust tube 130.

Based on the above, since the intake tube, the throat tube, and the exhaust tube of the invention form a convergent-divergent nozzle, based on the principles of aerodynamics, the gas passing through the intake tube, the throat tube, and the exhaust tube can be accelerated to supersonic speed. As a result, moisture from the gas can be excluded, and power consumption and operating costs can be lowered. Moreover, to ensure that the gas can still be pushed to the throat tube and reach a supersonic flow rate when the intake tube is in a low pressure state, the gas inside the exhaust tube can first be extracted with the pump and then be transported to the control valve through the first communication tube. Then, the exterior and the first communication tube are communicated through the control valve to emit the gas inside the exhaust tube to the exterior, and the pump and the control valve are turned off after the atmospheric pressure inside the intake tube is relatively higher than the atmospheric pressure inside the exhaust tube. Next, the gas inside the intake tube is readily pushed to the throat tube and the exhaust tube with the pressure difference between the atmospheric pressure inside the intake tube and the atmospheric pressure inside the exhaust tube, and the gas is accelerated to supersonic speed.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A dehumidification apparatus suitable for collecting a gas of an exterior and excluding a moisture from the gas, wherein the dehumidification apparatus comprises:
an intake tube having a first end portion and a second end portion opposite to each other, wherein a cross-section of the intake tube is convergent from the first end portion to the second end portion;
a throat tube connected to the second end portion;
an exhaust tube connected to the throat tube, wherein the throat tube is located between the second end portion and the exhaust tube, and a cross-section of the throat tube is less than a cross-section of the exhaust tube; and
a communication device connected between the intake tube and the exhaust tube.

2. The dehumidification apparatus of claim 1, wherein a ratio between the cross-section of the throat tube and the cross-section of the exhaust tube is 1:1.2.

3. The dehumidification apparatus of claim 1, wherein the communication device comprises:
a first communication tube connected between the intake tube and the exhaust tube;
a control valve connected to the first communication tube; and
a pump connected to the first communication tube, wherein the pump is located between the exhaust tube and the control valve.

4. The dehumidification apparatus of claim 1, further comprising:
an airflow guiding device connected to the intake tube, wherein the intake tube is located between the throat tube and the airflow guiding device.

5. The dehumidification apparatus of claim 4, further comprising:
two pitot tubes respectively disposed inside the airflow guiding device and the exhaust tube.

6. The dehumidification apparatus of claim 4, wherein the airflow guiding device comprises:
a cover body;
a plurality of guide vanes pivoted inside the cover body and radially arranged about a central axis of the cover body; and
a second communication tube connected between the cover body and the first end portion, wherein a cross-section of the second communication tube is convergent from the cover body to the first end portion.

7. A dehumidification method, comprising:
providing a dehumidification apparatus comprising an intake tube, a throat tube, an exhaust tube, and a communication device connected between the intake tube and the exhaust tube, wherein the intake tube has a first end portion and a second end portion opposite to each other, a cross-section of the intake tube is convergent from the first end portion to the second end portion, the throat tube is connected between the second end portion and the exhaust tube, and a cross-section of the throat tube is less than a cross-section of the exhaust tube;
introducing a gas from an exterior from the first end portion with the intake tube, and accelerating the gas such that the gas enters the throat tube from the second end portion and reaches a supersonic speed when passing through the throat tube; and
continuously accelerating the gas with the throat tube and the exhaust tube, and excluding a moisture from the gas.

8. The method of claim 7, wherein a ratio between the cross-section of the throat tube and the cross-section of the exhaust tube is 1:1.2.

9. The method of claim 7, wherein the first communication device comprises:
a first communication tube connected between the intake tube and the exhaust tube;
a control valve connected to the first communication tube; and
a pump connected to the first communication tube and located between the exhaust tube and the control valve.

10. The method of claim 9, further comprising:
extracting the gas inside the exhaust tube with the pump and transporting the gas to the control valve through the first communication tube;
communicating the exterior and the first communication tube with the control valve to emit the gas inside the exhaust tube to the exterior and turning off the pump and the control valve after an atmospheric pressure inside the intake tube is relatively higher than an atmospheric pressure inside the exhaust tube; and
pushing the gas inside the intake tube to the throat tube and the exhaust tube with a pressure difference between the atmospheric pressure inside the intake tube and the atmospheric pressure inside the exhaust tube and accelerating the gas to the supersonic speed.

11. The method of claim 9, further comprising, before the gas is continuously accelerated with the throat tube and the exhaust tube and a normal shock is generated:
extracting the gas inside the exhaust tube with the pump and transporting the gas to the control valve through the first communication tube; and
communicating the intake tube and the first communication tube with the control valve to transport the gas inside the exhaust tube to the intake tube such that the gas is accelerated to the supersonic speed when passing through the throat tube.

12. The method of claim 7, further comprising:
connecting an airflow guiding device and the intake tube, wherein the intake tube is located between the throat tube and the airflow guiding device, the gas of the exterior is collected and entered into the intake tube with the airflow guiding device, and the gas rotates about a central axis of the airflow guiding device.

13. The method of claim 12, wherein the airflow guiding device comprises:
a cover body;
a plurality of guide vanes pivoted inside the cover body and radially arranged about a central axis of the cover body; and
a second communication tube connected between the cover body and the first end portion of the intake tube, wherein a cross-section of the second communication tube is convergent from the cover body to the first end portion of the intake tube.

14. The method of claim 12, further comprising:
respectively disposing two pitot tubes inside the airflow guiding device and the exhaust tube to detect a flow rate of the gas passing through the airflow guiding device and a flow rate of the gas passing through the exhaust tube.
